(19) United States
(12) Patent Application Publication
(10) Pub. No.: US 2015/0222385 A1
(43) Pub. Date: Aug. 6, 2015

(54) TRANSPONDER FOR WDM RING NETWORK

(71) Applicants: Filippo Ponzini, Pisa (IT); Luca Giorgi, Ponsacco (PI) (IT)

(72) Inventors: Filippo Ponzini, Pisa (IT); Luca Giorgi, Ponsacco (PI) (IT)

(73) Assignee: Telefonaktiebolaget L M Ericsson (publ), Stockholm (SE)

(21) Appl. No.: 14/416,623

(22) PCT Filed: Jul. 26, 2012
(86) PCT No.: PCT/EP2012/064725

§ 371 Date: Jan. 22, 2015

(51) Int. Cl. H04J 14/02; H04B 10/572; H04B 10/275

(52) U.S. Cl. CPC H04J 14/0202; H04B 10/275; H04B 10/572

(57) ABSTRACT

For a WDM ring network, a node has an optical add drop part and a transponder having a wavelength tunable transmitter for sending a selectable one of the wavelengths in a selectable direction around the ring to a destination node. There is a controller configured to select the wavelength to be sent by the wavelength tunable transmitter and to change the direction of sending around the ring, in response to a detection of a fault in sending in one of the directions. By making the transponder colourless and yet able to select direction, a simple protection switching capability can be added to an existing low cost WDM ring network having passive optical filters. This can be achieved without the need for a reconfigurable optical add drop multiplexer and associated control plane.

### FIELD

The present invention relates to WDM ring networks, to nodes for such WDM ring networks, and to transponders for such nodes, to corresponding methods of operating nodes, and to corresponding computer programs.

### BACKGROUND

In transport networks, DWDM technology offers many benefits in terms of bandwidth capabilities and scalability. WDM-PON brings this benefit also in access networks, offering high capacity (upgradeable to 10 Gb/s), long distances, no bandwidth contention (virtual point-to-point) and service transparency, together with the possibility of smooth upgrades (per channel) in the protocol and in the bit-rate. WDM-PON is an emerging technology also for mobile backhaul, since broadband services and bandwidth demands are quickly increasing. A conventional WDM-PON is realized with a tree topology with a passive AWG at the remote node (RN) acting as a distribution node for mux/demux of the channels. This topology supports a high number of ONTs with the same kind of ONT for any AWG port (colorless)

In mobile backhaul WDM-PON permits ultra-broad dedicated bandwidth for each radio base station with high aggregation capacity (up to 961×10 Gb/s), very low latency, possibility to serve high density and rural areas with the same infrastructure and again the possibility to share the same infrastructure for mobile, residential and business access (Multi-service network).

Conventional WDM-PON networks based on tree topology represent an open and scalable network solution not only for conventional access, but also in metro transport and backhauling scenarios. Despite advantages in terms of bandwidth, scalability and transparency, they suffer from being limited to a tree topology. Nevertheless they are low cost, easy to deploy and able to reach many users with reduced costs for fiber digging, compared to point to point links.

WDM-PON technology aims to bring WDM benefits in terms of high capacity, protocol transparency and end to end connectivity closer to the final user, with lower cost per bit. In recent years the notable increase in mobile broadband has been driving the demand for low cost and scalable optical backhauling. However WDM-PON technologies and solutions that are low cost are held back by a lack of resilience to faults, which is seen as necessary today for enterprise and high value access and in the future for applications such as the next generation LRAN mobile backhauling.

### SUMMARY

Embodiments of the invention provide improved methods and apparatus. According to a first aspect of the invention, there is provided a node for a WDM ring network, the node having an optical add drop part and a transponder. The optical add drop part has optical add filters and optical drop filters for respectively adding and dropping selected wavelengths in clockwise and anti-clockwise directions around the ring. The transponder has a wavelength tunable transmitter having first and second output optical paths coupled to respective optical add filters for clockwise and anti-clockwise directions, of the optical add drop part, for sending a selectable one of the wavelengths in a selectable direction around the ring to a destination node. The transponder also has a controller for the wavelength tunable transmitter configured to select the wavelength to be sent by the wavelength tunable transmitter and to change the direction of sending around the ring, in response to a detection of a fault in sending in one of the directions. By making the transponder colourless and yet able to select direction, a simple protection switching capability can be added to an existing low cost WDM ring network having passive optical filters. This can be achieved without the need for a reconfigurable optical add drop multiplexer and associated control plane for assigning and controlling wavelength allocations, as used in nodes of a typical metro optical transport network. Thus some of the resilience offered by such metro optical networks can be achieved at lower cost and lower complexity. See FIGS. 1, 2 and 3 for example.

Any additional features can be added or disclaimed and some such features are described in more detail. One such additional feature is the wavelength tunable transmitter comprising an optical source and a wavelength dependent splitter, configured to send some wavelengths to the first output optical path and other wavelengths to the second output optical part. This can enable the direction selection to be carried out by changing the wavelength, thus avoiding the need for an active part such as an optical switch. Such active parts are feasible options but a splitter is less complex and cheaper. See FIGS. 2 and 7 for example.

Another such additional feature is the controller being arranged to try sending different wavelengths and to cooperate with the destination node to identify which wavelength is added by the optical add drop part at the node and dropped by the optical add drop part at the destination node. This can enable the transponder to be more universal, suitable for any node, while the wavelength allocation can be set by the choice of filters in the add drop part. This can simplify the controller and reduce the need for interaction with any control plane, and make the physical layer more independent of higher layers. This can simplify installation and maintenance and reduce inventory and thus reduce costs. Another such additional feature is the transponder having a receiving part having two input optical paths, one configured to receive a wavelength from the optical drop filter for the clockwise direction and the other input path configured to receive a wavelength from the optical drop filter for the anti-clockwise direction. This can enable bidirectional traffic and enable both directions to be protected. See FIG. 2 for example. Another such additional feature is the controller being arranged to control the transponder to swap the wavelength being sent for the wavelength previously being received, when changing the direction of sending. Provided the destination node does the same, then this enables the same pair of wavelengths to be used for the protection path as for the working path, which simplifies wavelength allocation and conserves wavelengths. By swapping the incoming and outgoing wavelengths for each other rather than keeping them unswapped, the possibility of using the wavelength dependent splitter to change sending direction passively is maintained. See FIGS. 4, 7, 8 and 9 for example.

Another such additional feature is the receiving part having a monitor to detect if the destination node starts sending in a different direction, and the controller being arranged to control the transponder to change the direction of sending in response to the detection. This helps enable incoming and outgoing directions to be changed almost simultaneously without the delay or complexity of signaling between the source and destination nodes. See FIG. 4 for example.

Another such additional feature is the controller being configured to have a slave mode in which no wavelength is sent until the receiving part detects an incoming wavelength from another node, then the controller determines which wavelength to send based on a timing of a presence and absence of the incoming wavelength.

This can help enable a master-slave type cooperation between pairs of nodes to enable pairs of wavelengths to be selected to match the add drop filters, without needing a separate signaling channel or any other indication from the filters or from any external network management system. Thus again costs of hardware and configuration and maintenance can be reduced. See FIG. 6 for example.

Another such additional feature is the optical add drop part comprising a part of a distributed AWG. See FIGS. 1 and 9 for example.

Another such additional feature is the transponder being configured to be able to send any of the wavelengths across the range used by the WDM network. This can help enable the same transponder to be used by all nodes to maximize the universality and consequential benefits of cost reduction and ease of installation and maintenance. See FIGS. 1, 8 and 9 for example.

Another aspect provides a transponder for use with a WDM ring network, the ring network having nodes, each node having optical add filters and optical drop filters for respectively adding and dropping selected wavelengths in clockwise and anti-clockwise directions around the ring. The transponder has a wavelength tunable transmitter having first and second output optical paths for coupling to respective optical add filters for clockwise and anti-clockwise adding at a source node of the ring, for sending a selectable one of the wavelengths in a selectable direction around the ring to a destination node. A controller is provided for the wavelength tunable transmitter configured to select the wavelength to be sent by the wavelength tunable transmitter and to change the direction of sending around the ring, in response to a detection of a fault in sending in one of the directions. This covers the transponder with or without the DAWG, see FIG. 2 or FIG. 7 or FIG. 8 for example.

Another aspect provides a WDM ring network having two or more of the nodes and being a passive network with no optical amplification and no active optical switches. Another aspect provides a method of operating a node of a WDM ring network, the node having an optical add drop part and a transponder the optical add drop part having optical add filters and optical drop filters for respectively adding and dropping selected wavelengths in clockwise and anti-clockwise directions around the ring, and the transponder having a wavelength tunable transmitter having first and second output optical paths coupled to respective optical add filters for clockwise and anti-clockwise directions, of the optical add drop part, for sending a selectable one of the wavelengths in a selectable direction around the ring to a destination node. The method has steps of using the wavelength tunable transmitter to send data traffic to the destination node using a first wavelength, and receiving an indication of a fault in the operation. The wavelength tunable transmitter is controlled to change the wavelength to be sent by the wavelength tunable transmitter and to change the direction of sending around the ring, in response to a detection of the fault. See FIG. 3 for example.

Another such additional feature is the step of initializing the transponder by trying sending different wavelengths in sequence and cooperating with the destination node to identify which of the wavelengths is added by the optical add drop part at the node and dropped by the optical add drop part at the destination node. See FIGS. 5, 10 and 11 for example.

Another such additional feature is the transponder having a receiving part having two input optical paths, one configured to receive a wavelength from the optical drop filter for the clockwise direction and the other input path configured to receive a wavelength from the optical drop filter for the anti-clockwise direction. There is also a step of controlling the transponder to swap the wavelength being sent for the wavelength previously being received, when changing the direction of sending. See FIGS. 2 and 4 for example.

Another such additional feature is the step of detecting if the destination node starts sending in a different direction, and the step of controlling the transponder to change the direction of sending in response to the detection. See FIG. 4 for example.

Another such additional feature is initializing the transponder by sending no wavelength until the receiving part detects an incoming wavelength from another node, then determining which wavelength to send based on a timing of a presence and absence of the incoming wavelength. See FIGS. 6 and 10 for example.

Another aspect provides a computer program for a controller of a node and having instructions which when executed by a processor of the controller cause the controller to carry out the method. See FIGS. 2 and 3 for example.

Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of a WDM ring having transponders according to embodiments,

FIG. 2 shows a node having a transponder according to an embodiment,

FIG. 3 shows method steps involved in responding to a fault according to an embodiment,

FIG. 4 shows method steps involved in changing direction of sending around the ring according to an embodiment,

FIGS. 5 and 6 show method steps in initializing a sending wavelength according to embodiments,

FIG. 7 shows a schematic view of a transponder with client side according to an embodiment.

FIG. 8 shows an ONT according to an embodiment,

FIG. 9 shows a ring having nodes having transponders and distributed AWGs according to an embodiment,

FIG. 10 shows operational steps for a node in a master mode, and

FIG. 11 shows operational steps for a node in a slave mode.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

### DEFINITIONS

Where the term “comprising” is used in the present description and claims, it does not exclude other elements or steps and should not be interpreted as being restricted to the means listed thereafter. Where an indefinite or definite article is used when referring to a singular noun e.g. “a” or “an”, “the”, this includes a plural of that noun unless something else is specifically stated.

Elements or parts of the described base stations, nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to software can encompass any type of programs in any language executable directly or indirectly on processing hardware.

References to processors, hardware, processing hardware or circuitry can encompass any kind of logic or analog circuitry, integrated to any degree, and not limited to general purpose processors, digital signal processors, ASICs, FPGAs, discrete components or logic and so on. References to a processor are intended to encompass implementations using multiple processors which may be integrated together, or co-located in the same node or distributed at different locations for example.

### ABBREVIATIONS

### AWG Array Waveguide Gratings

### CPRI Common Public Radio Interface

### C-RAN Centralized RAN

### HW Hardware

### LOS Loss of Signal

### L-RAN Low RAN

### MU Main Unit

### O&M Operation & Maintenance

### ONT Optical Network Terminal

### PON Passive Optical Network

### RAN Radio Access Network

### ROADM Reconfigurable Optical Add/Drop Multiplexer

### RRU Remote Radio Unit

### RX Receiver

### TX Transmitter

### WDM Wavelength Division Multiplexing

Introduction to Issues with Conventional Designs

By way of introduction to the embodiments, how they address some issues with conventional designs will be explained. Conventional WDM networks, in particular metro rings, are too expensive and not sufficiently “scalable” to be used for upcoming LRAN backhauling. At the same time conventional WDM PON solutions have not been developed for backhauling and it hardly suits already deployed fiber ring. Again it barely supports protection. Conventional WDM rings, in particular the ones used for mobile backhauling or for CPRI transport in C-RAN, do not offer low cost protection schemes. Thus such current solutions are not able to combine WDM-PON “low cost” and agile O&M with the resilience offered by metro transport solutions based on ROADMs.

### Introduction to Features of Embodiments

To address these issues, a simple enhancement of WDM-PON transceivers (ONT) is described, able to add resilience in WDM-PON rings based on the concept of distributed AWG. It can be combined with an auto-configuration method as will be described. Arranging WDM-PON equipment in ring topologies can help keep low costs, low power consumption and agile transport layers, typical of WDM-PON. One feature which helps enable this is the concept of the “distributed AWG”. It can in some cases enable re-use of the same HW equipment for OLT and ONTs on a ring topology. In some cases the distribution node of the PON, conventionally implemented by an AWG, will be replaced by passive elements distributed around a first optical path which may be a ring structure, so as to drop different wavelengths at different nodes. This is a cheap and easy way to adapt WDM-PON equipment to a ring topology. Rings are typically easier to deploy than tree topologies and they offer low dig costs and often use less fiber for a given number of nodes. Thus they can be suitable for applications such as mobile backhaul applications where there are clusters of non-colocated RRUs far from the Main/Baseband Unit.

A pair of ONTs on the ring is configured to set-up a bidirectional communication using a couple of wavelengths. Both the wavelengths can be arranged to travel along the same ring segment. This can help to support protocols not able to tolerate differential delays between uplink and downlink, such as CPRI. If a failure occurs in the active ring segment, the devices are able to “reuse” the same couple of wavelengths in the opposite directions. Everything happens automatically through a “swap” of the two wavelengths. This effectively exploits the concept of non-hierarchical WDM to further increase the automatic configuration of each transponder. This helps reduce or avoid the need for interaction with a control plane and thus can reduce O&M costs.

A non-hierarchical approach also enables use of just one type of transceiver (ONT) along the ring. Each ONT is able to auto-reconfigure itself according with the connectivity needs, and to set up communication with another ONT on the ring. Again in “Non-hierarchical WDM-PON” all optical terminations (ONTs) are equivalent, with major benefits in terms of deployment flexibility. It is also possible to easily re-use the fiber already available. Embodiments as described can provide low-cost “protection” in Non-hierarchical WDM-PON Rings. This is obtainable through a low cost HW “enhancement” of tunable lasers based ONTs, and a method of operation which can make the ONT self-adaptive without needing interaction with a control plane for example.

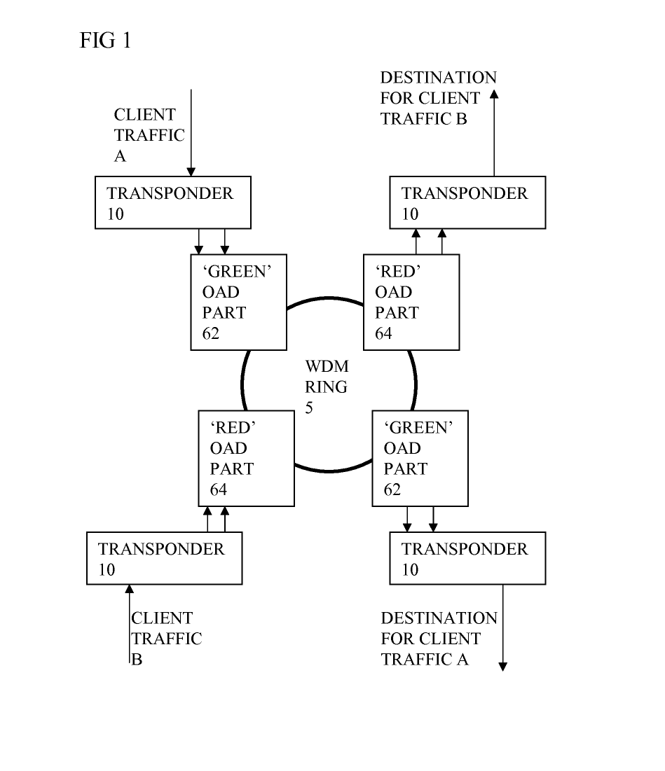

FIG. 1, WDM Ring Having Transponders According to an Embodiment

FIG. 1 shows a schematic view of a WDM ring 5 having a number of nodes, each node having a transponder 10 and an Optical Add Drop OAD part 62, 64. Client traffic A shown at top left is fed to a transponder which provides two optical signals having a predetermined wavelength which is labeled here as “Green”, to “Green” OAD part 62. This OAD part is capable of adding one of the optical signals to the ring in a clockwise direction and the other of the optical signals in an anti-clockwise direction. One direction is treated as the working path and the other direction as the protection path. The OAD parts which are labeled as “red” will only add or drop other wavelengths and will ignore the “green” wavelength signals. The “green” OAD part shown at the bottom right is the destination for the client traffic A and so is set up to drop the “green” wavelength signals from anti clockwise and clockwise directions, and pass them to the transponder. The transponder is able to select and receive the working path signal and output traffic A to the client. In the event of a fault, the pair of transponders can cooperate to use the optical signal going in the other direction around the WDM ring for the traffic A. Only one direction is shown for the client traffic, and in principle one directional traffic can be used though in many embodiments the traffic is bidirectional and each node will be arranged to carry bidirectional traffic. More details of how to implement this in various ways will now be described.

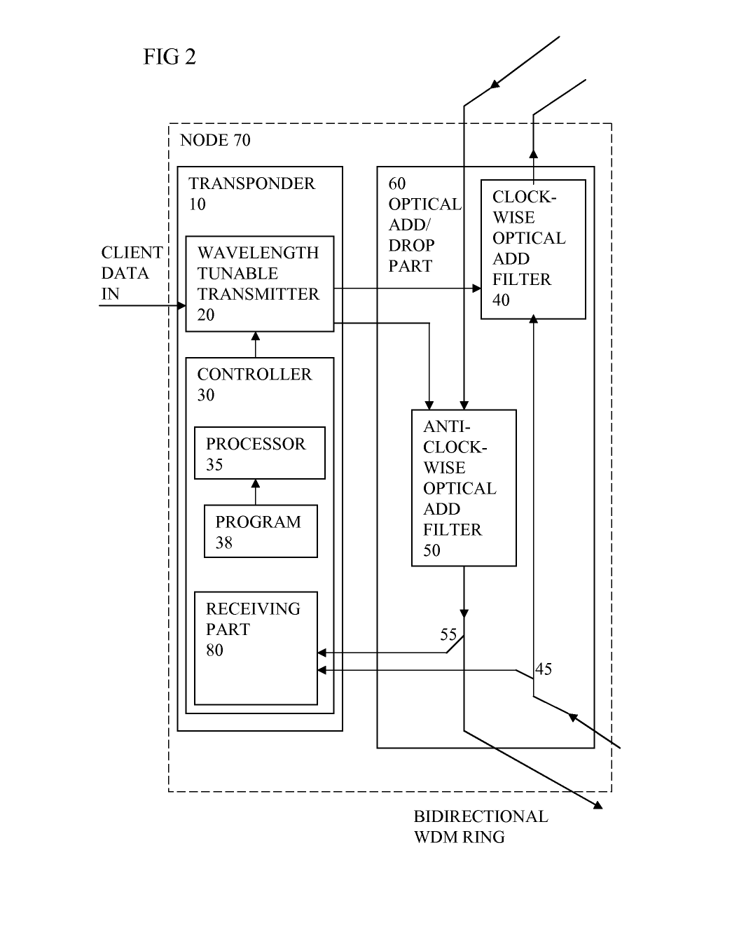

FIG. 2 Node According to an Embodiment

FIG. 2 shows a schematic view of a node suitable for use in the arrangement of FIG. 1 or in other arrangements. The node has a transponder 10 and an optical add/drop part 60. The transponder has a wavelength tunable transmitter 20, and a controller 30. The optical add drop part has optical add filters 40, 50 and optical drop filters 45, 55 for respectively adding and dropping selected wavelengths in clockwise (40, 45) and anti-clockwise (50, 55) directions around the ring. Although the ring is shown as having separate paths for each direction, in practice both paths can use the same single fiber. The wavelength tunable transmitter 20 has a first output optical path coupled to the clockwise optical add filter 40. A second output optical path is coupled to the anti-clockwise optical add filter 50. This enables sending a selectable one of the wavelengths in a selectable direction around the ring to a destination node.

The controller 30 for the wavelength tunable transmitter has a processor 35 and program 38 in a memory, configured to select the wavelength to be sent by the wavelength tunable transmitter and to change the direction of sending around the ring, in response to a detection of a fault in sending in one of the directions. A receiving part 80 is coupled to receive optical signals dropped from the ring by clockwise drop filter 45 and anticlockwise drop filter 55.

By making the transponder colourless and yet able to select direction, a simple protection switching capability can be added to an existing low cost WDM ring network having passive optical filters. This can be achieved without the need for a reconfigurable optical add drop multiplexer and associated control plane for assigning and controlling wavelength allocations, as used in nodes of a typical metro optical transport network. Thus some of the resilience offered by such metro optical networks can be achieved at lower cost and lower complexity

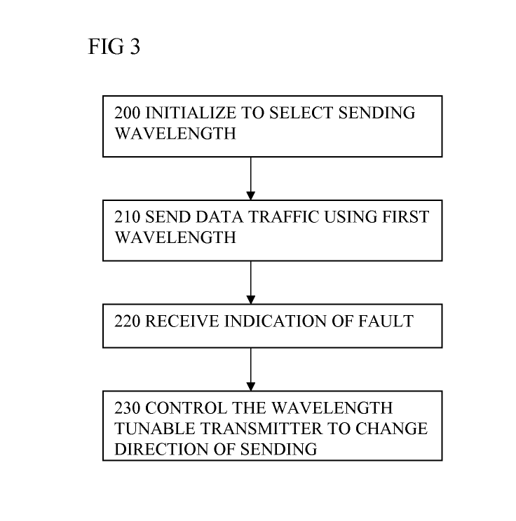

FIG. 3 Steps in Responding to a Fault

FIG. 3 shows method steps by a transponder involved in responding to a fault according to an embodiment. At step 200 an initialization step results in selecting a sending wavelength, and sending data traffic at step 210 using the first wavelength. This can be in either clockwise or anticlockwise directions. At step 220, an indication of a fault is received. This can be received or detected at the receiver part of the transponder, or detected externally and passed on to the transponder in any way. At step 230, the controller of the transponder controls the wavelength tunable transmitter to change a wavelength of sending and to change a direction of sending. This may be done with an active optical component, or more efficiently and cheaply by a passive optical component as will be explained in more detail below.

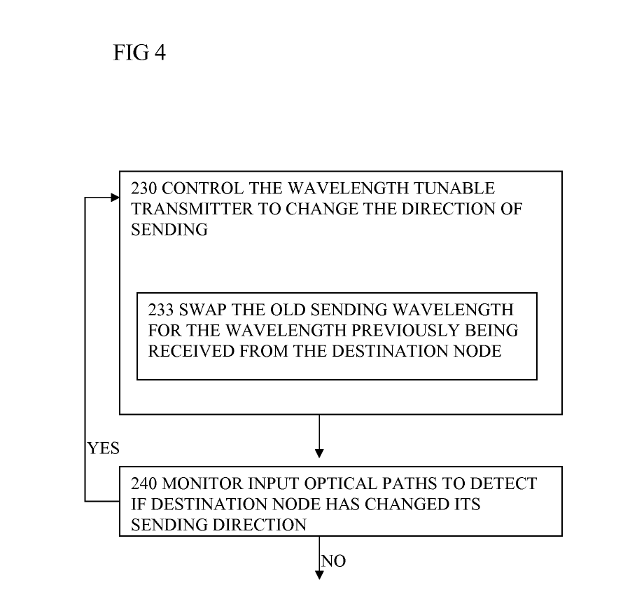

FIG. 4, Changing Direction of Sending

FIG. 4 shows method steps which may be involved in the step 230 of changing direction of sending around the ring according to an embodiment. This can be implemented by a step 233 of swapping the old sending wavelength for the wavelength previously being received from the destination node. At step 240 the tranponder monitors the input optical paths to detect if the destination node has changed ints sending direction. This may involve detecting the presence of an optical signal, or in more complex embodiments it may be some characteristic or content of the optical signals which indicates which is being used as the working path, or whether the protection path is to be used.

If a change in direction from the destination end is detected then the transponder changes its direction of sending also, so that both directions of the bidirectional traffic use the same path.

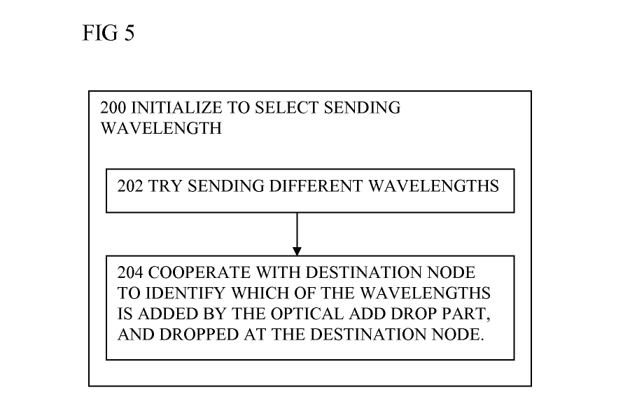

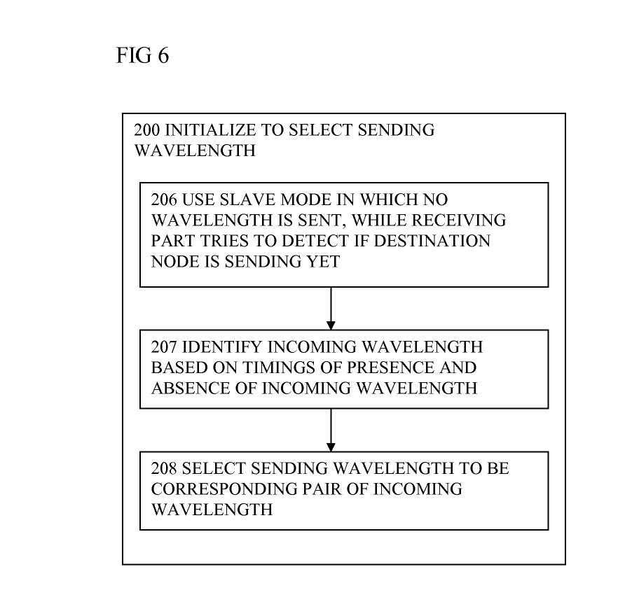

FIGS. 5 and 6 Initializing Steps

FIGS. 5 and 6 show initializing steps for selecting a wavelength for sending, according to embodiments. This assumes that the add drop parts are preconfigured to use certain wavelengths, but the transponder is universal and not preconfigured to use a certain wavelength, which would be more complex to install and to maintain inventory. At step 202 of FIG. 5 there is a step of trying to send various different wavelengths. At step 204 the transponder cooperates with the destination node to identify which of the wavelengths has successfully reached the destination, which depends on which wavelengths are added and dropped by the OAD parts. This enables the transponders to be universal and not have prior knowledge of the configuration of the OAD parts, so they can be swapped or replaced more easily.

FIG. 6 shows alternative initializing steps. In this case the transponder uses a slave mode at step 206, in which no wavelength is sent, while the receiving part tries to detect if the destination node is sending yet. At 207 if it detects an optical signal from the destination node, then it identifies the incoming wavelength based on for example the timings of presence and absence of the incoming wavelength. Other possibilities are feasible, such as having multiple detectors each having different optical filters, but these are likely to be more expensive to implement. At step 208 a sending wavelength is selected so as to be a corresponding pair with respect to the incoming wavelength. This relies on knowledge that the OAD parts are configured to use corresponding pairs of wavelengths so that if one wavelength is known then the other can be deduced.

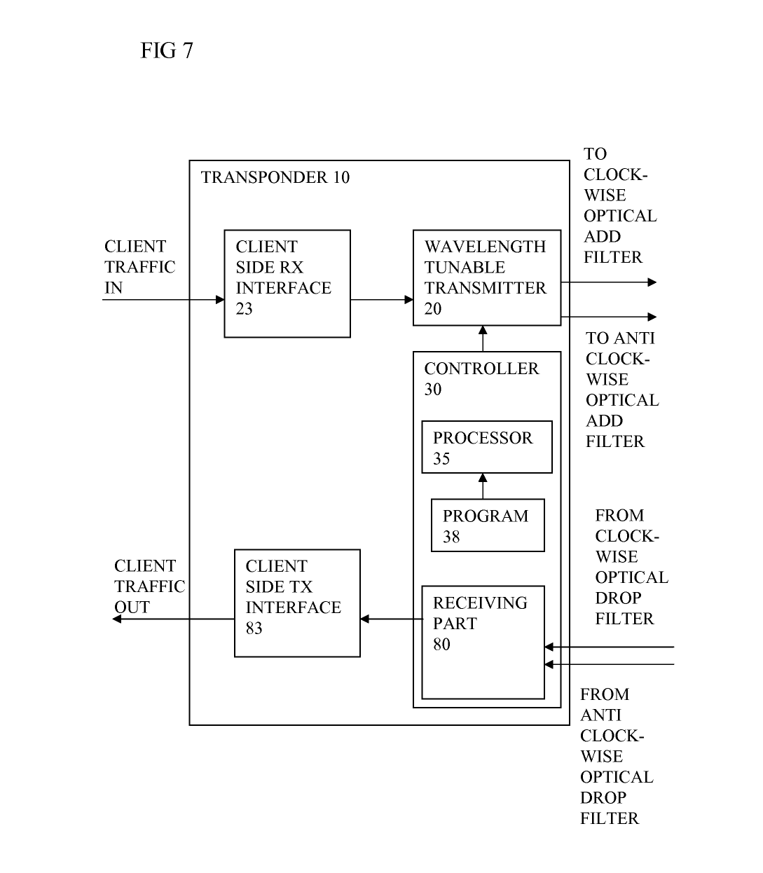

FIG. 7, Transponder Showing Client Side

FIG. 7 shows a schematic view of a transponder 10. As in FIG. 2 the transponder has a wavelength tunable transmitter 20, and a controller 30. The wavelength tunable transmitter 20 has a first output optical path coupled to the clockwise optical add filter. A second output optical path is coupled to the anti-clockwise optical add filter. The controller 30 for the wavelength tunable transmitter has a processor 35 and program 38 in a memory, configured to select the wavelength to be sent by the wavelength tunable transmitter and to change the direction of sending around the ring, in response to a detection of a fault in sending in one of the directions. A receiving part 80 is coupled to receive optical signals dropped from the ring by clockwise drop filter and anticlockwise drop filter. A client side of the transponder has a client side RX interface 23 for receiving incoming client traffic and passing it to the wavelength tunable transmitter. The client side also has a client side TX interface 83 for taking traffic received at the receiving part 80 and passing it on to the client in whatever format and physical path is specified by the client. The client side of the transponder may have functions to monitor the client traffic in and out and to detect and report faults and so on.

Transponders are typically able to carry out symmetric full-duplex communication, meaning traffic can pass from the source node to the destination node and, vice versa, at the same time as traffic that passes in the other direction.

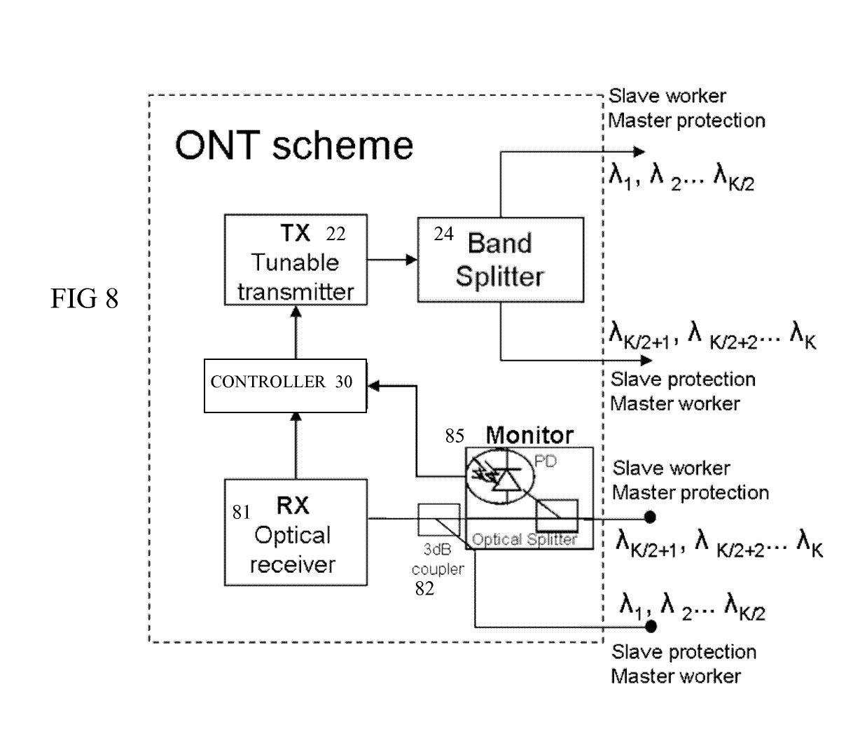

FIG. 8, ONT Transponder According to an Embodiment

FIG. 8 shows a schematic view of a transponder in the form of an ONT according to an embodiment. This ONT can be based on tunable laser technology and differs from a conventional ONT by having two additional components, a band splitter 24 and a monitor 85 as will be explained. It is configured to cooperate with a similar transponder at the destination node so that a bidirectional communication is set up between each couple of ONTs: one of them acts as a “master” and the other one as a “slave”. A tunable transmitter 22 is coupled to provide an optical signal to the band splitter 24. The band splitter is a passive device which depending on the wavelength, outputs the optical signal two one of two output ports. In this case if the wavelength is between λ₁ and λ₂, then it outputs the optical signal to the upper port for use as a protection path when in a master mode, or as a worker path when in a slave mode. If the wavelength is between λ_{K/2+1} and λ_{K}, then it outputs the optical signal to the lower port for use as a protection path when in a slave mode, or as a worker path when in a master mode.

There is an optical receiver 81 coupled to both input optical paths by a coupler 82. The monitor 85 is coupled to one of the input optical paths and typically has an optical splitter and a photodiode PD arranged to detect presence of absence of an optical signal. If absent, it is assumed that there is a signal on the other path, or this can be confirmed by the optical receiver 81. In this case the wavelengths expected on the incoming paths can be the same ranges of wavelengths as are sent out, but swapped so that the wavelengths between λ₁ and λ_{K/2} are on the lower of the incoming paths, for use as a protection path when in a slave mode, or as a worker path when in a master mode. The upper path is used for wavelengths between λ_{K/2+1} and λ_{K}, for use as a protection path when in a master mode, or as a worker path when in a slave mode.

The band splitter is one way to enable use of both the ring directions, according to the transmitter wavelength. In principle an active device such as an optical switch could be used, but would be more complex and expensive. The optical power monitor enables the transponder to detect whether the other end is acting as a master or a slave and thus can avoid a stalemate if both devices act as a slave for example. This helps in making possible a low cost and automatic protection mechanism which is relatively autonomous and thus can avoid or reduce the need for interaction with a control plane for example, and reduces the need for correct configuration information when installing.

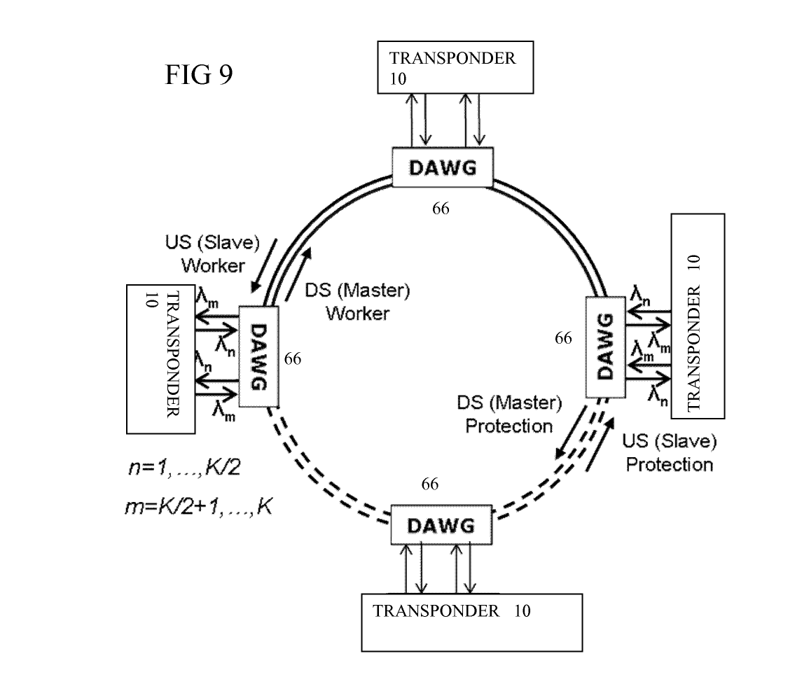

FIG. 9, Ring with DAWGs

FIG. 9 shows a ring having nodes having transponders and distributed AWGs according to an embodiment. This shows a similar view to that of FIG. 1. The OAD parts are implemented as DAWGs 66, and are each configured to add and drop one or several specified wavelengths. The OAD Part implemented as a DAWG can make use of a 6 port device, but at any moment in time there is optical light only on 4 of the ports: the two port connected to the WDM ring, one add port and one drop port. On the WDM ring fiber (typically there is only one fiber with optical signals travelling in both directions) there are many wavelengths travelling in both the possible directions. In each OAD part only two wavelengths are affected, one for transmitted traffic and one for received traffic, and other wavelengths pass through unaffected.

In FIG. 9 a non-hierarchical WDM-PON ring is shown with four nodes or taps (referred to as top, bottom, left, and right). Each tap performs as a distributed AWG, each tap is able to add or inject a pair of wavelengths. (Or even more than one pair, it depends on how many transponders need to be connected at each tap). The transponder 10 at each tap is coupled to the DAWG by four optical paths as shown in more detail in FIGS. 7 and 8.

The “worker” paths in both directions between the “left” and “right” nodes are shown by solid lines going via the “top” node. “Protection” paths for a typical link are shown by dotted lines going via the “bottom” node in this view. The link between the two ONTs is set-up automatically looking for the first working direction along the ring. If a fault happens and the main path (worker) becomes unavailable, the role of the ONTs will change, such as the ring segment in use (protection). No additional wavelengths are involved, because the two wavelengths in use are simply swapped in this example, though other arrangements of wavelengths are possible. Each transponder can transmit or receive a pair of wavelengths selected from a range of wavelengths n=1 to K/2 and each of those wavelengths has a corresponding paired wavelength, in the range m=K/2+1 to K.

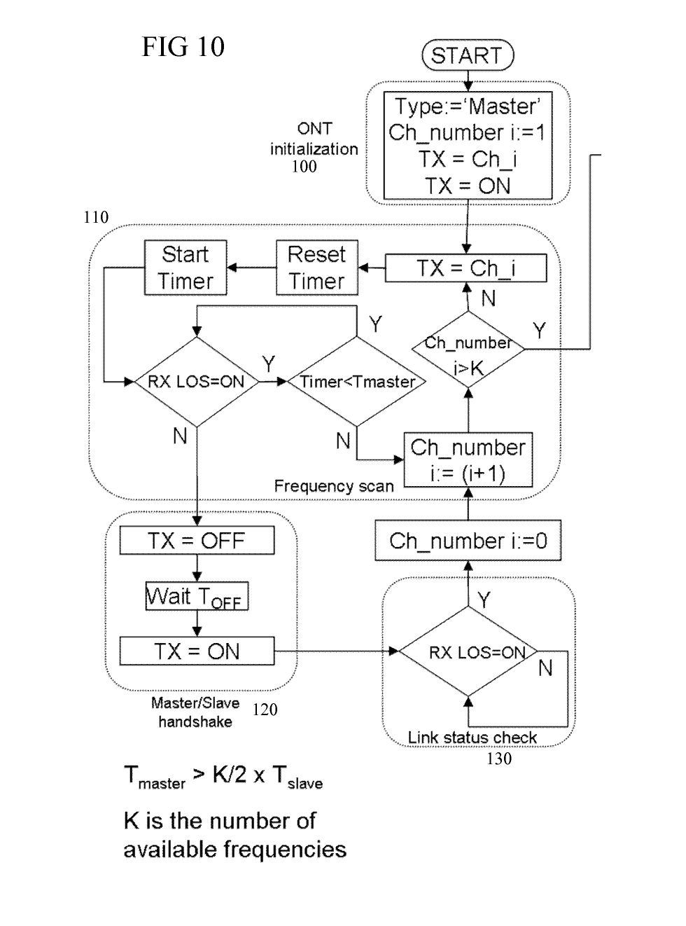

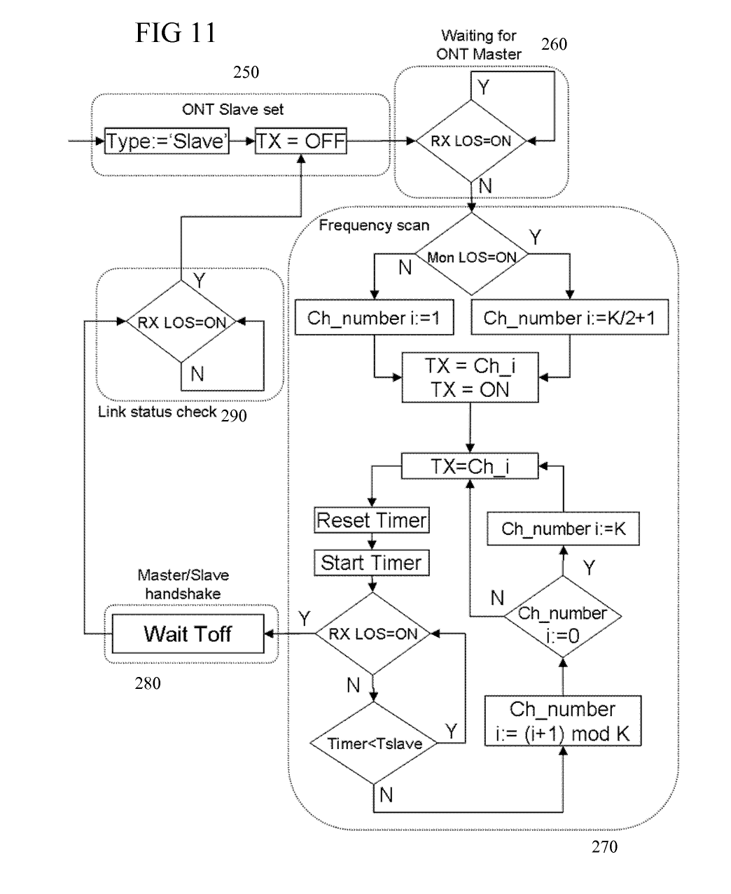

FIGS. 10 and 11 Steps for a Node in a Master Mode, and in a Slave Mode

For each pair of nodes, one should be in a master mode and the other in a slave mode, though they can swap roles in use. The “master” and “slave” conditions are decided through an automatic handshaking and configuration (detailed in the proposed method). The method can be summarized by the following steps:

When an ONT is connected for the first time to the network, it is in MASTER STATE and the tunable laser is switched on.

It starts the scanning of all the possible frequencies until the RX LOS flag is cleared (RX LOS=OFF). Each frequency is kept for a time interval T_{MASTER}. (T_{MASTER}>K/2×T_{SLAVE}, where K is the number of available frequencies) to check if the proper slave terminal is installed.

If a proper TX frequency is found and the slave is online, and handshake with the slave is started and the tuning procedure ends. An example is shown in more detail in FIG. 10.

If the ONT slave is not found after the scanning of all the frequencies (taking into account both directions) the transmitter is switched off and the ONT becomes “SLAVE” waiting for a master. An example is shown in more detail in FIG. 11.

In FIG. 10, on starting or connecting to the ring, the transponder initializes at step 100 and sets itself to master mode and sets an initial transmitting wavelength as channel 1 and switches the transmitter on. At step 110 a frequency scan is carried out. This involves sub steps of resetting a timer, starting the timer running and checking if any response wavelength is detected from the other transponder. If no then flag loss of signal LOS from the receiver is detected as “on” and when the timer expires the step is repeated for a next channel at a next wavelength by incrementing the channel number. If the channel number exceeds the last channel K then all the channels have been tried and it is assumed that the destination node is not yet installed and the next step is of setting the mode to a slave mode is shown in FIG. 11.

If the LOS flag goes off because a response is received, then step 120 the master slave handshake is carried out. This involves sub steps of switching off the transmitter for a wait period Toff and switching back on. Then a link status check step 130 is carried out. If the LOS flag goes on then the frequency scan of step 110 continues. Otherwise the master mode continues as long as the slave continues sending.

FIG. 11 shows at step 250 setting the mode as slave and switching off the transmitter. At step 260, the slave waits to receive from another node in a master mode which is indicated by a loss of signal flag from the receiver going off. This leads to a step 270 of sending an optical signal and scanning its frequency (meaning wavelength) until a successful wavelength is found matching the wavelength configured in the DAWGs at the source and destination nodes. This has sub steps of first checking if the monitor shows an LOS flag, to indicate which path a received signal is on. The result of this check determines which range of wavelengths is selected, which in turn determines whether the signal is transmitted clockwise or anti clockwise. The transmitter is switched on and the timer is reset and started. As long as the receiver loss of signal is not indicated, then that wavelength is transmitted until the timer expires. Then the channel number is changed and transmission started on a next wavelength. This continues endlessly unless the receiver loss of signal indication is indicated, which leads to the step 280 of the master slave handshake. This is a wait for time Toff followed by a link status check at step 290 which leaves the optical signals being transmitted and suitable for carrying traffic until there is a detection at step 290 of a receiver loss of signal indication. This leads to the transmitter being switched off at step 250 and the wait step 260 being repeated and so on.

Concluding Comments

Some benefits of features of embodiments are outlined by the following points: This can be a fully Non-hierarchical approach: just one type of device (the same hardware and the same software) is able to operate as a “master” or as a “slave”. For example, if used for CPRI transport, it means that a unique type of device can work in front of a MU such as in front of a RRU.

This can be fully auto-configurable: according with the supported wavelengths in each ring “tap” and with the WDM-PON “colorless” approach (any device is able to transmit and receive on any wavelength) the two devices will be able to find the proper set of wavelengths which are set in the OAD parts automatically without prior knowledge nor external communication with the OAD parts or any network control system.

There can be automatic resilience: if a link failure occurs, the devices involved are able to “exchange” their roles, swap the TX/RX wavelengths and use the alternative ring segment

Everything can happen automatically which leads to really simplified O&M which can save costs.

There is low cost largely because there is no expensive ROADM. If an OAD part is fitted but not used the assigned wavelengths will not be used, but the optical costs are maintained much lower than would be the case for an unused ROADM. There are plenty of applications (such as CPRI in C-RAN) where there is a surplus of wavelengths so that it is acceptable to waste some of them if there are relevant benefits in terms of costs.

Other variations can be envisaged within the claims.

1. A node for a WDM ring network, the node comprising:
an optical add drop part; and
a transponder,
wherein:
the optical add drop part has optical add filters and optical drop filters for respectively adding and dropping selected wavelengths in clockwise and anti-clockwise directions around the ring; and
the transponder has a wavelength tunable transmitter having first and second output optical paths coupled to respective optical add filters for clockwise and anti-clockwise directions, of the optical add drop part, for sending a selectable one of the wavelengths in a selectable direction around the ring to a destination node, and the transponder also has:
a controller for the wavelength tunable transmitter configured to select the wavelength to be sent by the wavelength tunable transmitter and to change the direction of sending around the ring, in response to a detection of a fault in sending in one of the directions.

2. The node of claim 1, wherein the wavelength tunable transmitter comprises an optical source and a wavelength dependent splitter, configured to send some wavelengths to the first output optical path and other wavelengths to the second output optical part.

3. The node of claim 1, wherein the controller is arranged to try sending different wavelengths and to cooperate with the destination node to identify which wavelength is added by the optical add drop part at the node and dropped by the optical add drop part at the destination node.

4. The node of claim 1, wherein the transponder has a receiving part having two input optical paths, one configured to receive a wavelength from the optical drop filter for the clockwise direction and the other input path configured to receive a wavelength from the optical drop filter for the anti-clockwise direction.

5. The node of claim 4, wherein the controller is arranged to control the transponder to swap the wavelength being sent for the wavelength previously being received, when changing the direction of sending.

6. The node of claim 4, wherein the receiving part has a monitor to detect if the destination node starts sending in a different direction, and the controller is arranged to control the transponder to change the direction of sending in response to the detection.

7. The node of any of claim 4, wherein the controller is configured to have a slave mode in which no wavelength is sent until the receiving part detects an incoming wavelength from another node, then the controller determines which wavelength to send based on a timing of a presence and absence of the incoming wavelength.

8. The node of claim 1, wherein the optical add drop part comprises a part of a distributed AWG.

9. The node of claim 1, wherein the transponder is configured to be able to send any of the wavelengths across the range used by the WDM network.

10. A transponder for use with a WDM ring network, the ring network having nodes, each node having optical add filters and optical drop filters for respectively adding and dropping selected wavelengths in clockwise and anti-clockwise directions around the ring, the transponder comprising:
a wavelength tunable transmitter having first and second output optical paths for coupling to respective optical add filters for clockwise and anti-clockwise adding at a source node of the ring, for sending a selectable one of the wavelengths in a selectable direction around the ring to a destination nodes; and
a controller for the wavelength tunable transmitter configured to select the wavelength to be sent by the wavelength tunable transmitter and to change the direction of sending around the ring, in response to a detection of a fault in sending in one of the directions.

11. A WDM ring network having two or more of the nodes of claim 1, and being a passive network with no optical amplification and no active optical switches.

12. A method of operating a node of a WDM ring network, the node having an optical add drop part and a transponder;
the optical add drop part having optical add filters and optical drop filters for respectively adding and dropping selected wavelengths in clockwise and anti-clockwise directions around the ring; and
the transponder having a wavelength tunable transmitter having first and second output optical paths coupled to respective optical add filters for clockwise and anti-clockwise directions, of the optical add drop part, for sending a selectable one of the wavelengths in a selectable direction around the ring to a destination node,
the method comprising:
using the wavelength tunable transmitter to send data traffic to the destination node using a first wavelength;
receiving an indication of a fault in the operation; and
controlling the wavelength tunable transmitter to change the wavelength to be sent by the wavelength tunable transmitter and to change the direction of sending around the ring, in response to a detection of the fault.

13. The method of claim 12 having the step of initializing the transponder by trying sending different wavelengths in sequence and cooperating with the destination node to identify which of the wavelengths is added by the optical add drop part at the node and dropped by the optical add drop part at the destination node.

14. The method of claim 12, wherein the transponder has a receiving part having two input optical paths, one configured to receive a wavelength from the optical drop filter for the clockwise direction and the other input path configured to receive a wavelength from the optical drop filter for the anti-clockwise direction, and the method having the step of controlling the transponder to swap the wavelength being sent for the wavelength previously being received, when changing the direction of sending.

15. The method of 14, having the step of detecting if the destination node starts sending in a different direction, and the step of controlling the transponder to change the direction of sending in response to the detection.

16. The method of claim 14, having a step of initializing the transponder by sending no wavelength until the receiving part detects an incoming wavelength from another node, then determining which wavelength to send based on a timing of a presence and absence of the incoming wavelength.

17. A nontransitory processor-readable storage medium comprising a computer program for a controller of a node and having instructions which when executed by a processor of the controller cause the controller to carry out a method of operating a node of a WDM ring network, the node having an optical add drop part and a transponder;
the optical add drop part having optical add filters and optical drop filters for respectively adding and dropping selected wavelengths in clockwise and anti-clockwise directions around the ring; and
the transponder having a wavelength tunable transmitter having first and second output optical paths coupled to respective optical add filters for clockwise and anti-clockwise directions, of the optical add drop part, for sending a selectable one of the wavelengths in a selectable direction around the ring to a destination node,
the method comprising:
using the wavelength tunable transmitter to send data traffic to the destination node using a first wavelength;
receiving an indication of a fault in the operation; and
controlling the wavelength tunable transmitter to change the wavelength to be sent by the wavelength tunable transmitter and to change the direction of sending around the ring, in response to a detection of the fault.
